(19) United States
(12) Patent Application Publication
(10) Pub. No.: US 2006/0020510 A1
(43) Pub. Date: Jan. 26, 2006

(54) Method for improved targeting of online advertisements

(76) Inventor: Herb D. Vest, Dallas, TX (US)

Correspondence Address: CARSTENS & CAHOON, LLP, P O BOX 802334, DALLAS, TX, 75380, US

(21) Appl. No.: 10/928,063

(22) Filed: Aug. 27, 2004

Related U.S. Application Data
(60) Provisional application No. 60/589,336, filed on Jul. 20, 2004.

(51) Int. Cl. G06Q 30/00

(52) U.S. Cl. 705/14

(57) ABSTRACT

A computerized method for targeting advertisements toward certain groups of on-line users utilizes an advertising server to deliver the advertisements to on-line users. The advertising server passes information about the specific advertisement shown to the user and the placement of the advertisement on a content publisher's web site to the advertiser. The advertiser correlates this data with data collected on the advertiser's web site about the user to determine the most effective advertisements and placements for a certain group of on-line users.

### CROSS-REFERENCE TO RELATED APPLICATION

This application claims the benefit of and priority to a U.S. Provisional Patent Application No. 60/589,336 filed Jul. 20, 2004, the technical disclosure of which is hereby incorporated herein by reference.

### BACKGROUND OF THE INVENTION

1. Technical Field of the Invention:

The present invention relates to a method of improved targeting of on-line advertisements. Specifically, it relates to the correlation of advertisement content and placement information with information collected by an advertiser's web site. Furthermore, it relates to techniques and methods utilized to associate such information. It also relates to means of focusing advertising toward certain user groups after analyzing the available information.

2. Description of the Related Art:

Advertising on the Internet is an extremely competitive business area. Advertising rates on the Internet are frequently based on the number of Internet user impressions. An impression is a single showing of an advertisement to an Internet user. For example, a website such as www.yahoo.com might charge $20.00 for 1000 impressions of a specific advertisement. The rate is commonly quoted in terms of CPM or cost per thousand impressions.

Current advertising servers and advertisers track the click-through rate for each advertisement and some track its placement (the web site, the specific page and the location on the web page). This click-through rate helps the advertiser determine which advertisements are most effective and which advertisements are least effective in bringing users to the web site. Advertisers obviously prefer to show advertisements with higher click-through rates, because more Internet users visit the advertisers website for a given number of impressions.

Several different systems exist for companies to advertise on the Internet. One of the most commonly used systems involves the use of an advertising server. Additionally, a number of companies exist whose primary function is to collect and coordinate the distribution of advertisements to advertising servers. The advertising server described may be a single computer or a combination of machines, i.e. one machine on a network may provide the advertisement while another machine manages the gathering and recording of data including relevant associated advertising data and passively acquired user data after the user clicks on the advertisement, such as IP address, browser used, and date and time. Regardless of the setup, an advertising server system still accomplishes the tasks described herein. An advertising server stores the video/audio data for an advertisement and some associated data on the advertising server's computer system. This advertisement can be in any audio/video form, such as MPEG, JPEG, GIF, WMA, MP3, PNG, or any other format. Advertisements may also be as simple as a short string of text such as the advertisements used by Google. The associated data contains information such as the target URL, alternate display text, or an advertising identifier. The advertising server stores the advertisement and sends it an online user when a request is received. The user's browser may generate a request when the user visits any content publisher, i.e., www.yahoo.com or www.msnbc.com, and the content publisher's web page instructs the user's browser to show an advertisement from an advertising server. Thus when the user views the content publisher's content they also see the advertisement provided by the advertising server.

As discussed above, successful advertisements are currently measured by the click-through rate, or the percentage of impressions that generate a visit to the advertiser's web site. The information about advertising success rates is usually collected by the advertising server and reported to the advertiser in a summary form. The advertiser uses this information to track the particular advertisements that in certain placements on certain content publisher's web sites resulted in the most users visiting the advertiser's web site. However, the advertiser cannot identify which groups of users respond to certain advertisements. Generally, either the advertiser or the advertising server may be able to discover the location of the user, the user's domain name (i.e. aol.com or earthlink.net), and using a persistent cookie the advertising server may be able to ascertain information such as the number of advertisements seen or clicked on by a specific user.

After a user on a web page clicks on the advertisement, such as a banner ad or a text ad, then the user's browser will be directed to that advertiser's website. When on-line users on the advertiser's web site register in a community, purchase goods, or order services, the users generally provide a great deal of personal information to the advertiser. For instance, web sites offering dating services may collect information about user's age, sex, location, income level, preferences, and hobbies. Retail businesses may track a user's purchase history, location, or a list of viewed products. More importantly, advertisers are also able to track the amount of revenue generated over a long period of time by a certain user. Advertisers use this information to target services toward certain groups of users that have already registered and may show an interest in the particular goods and services. However, it is not currently possible to target advertising on a content publisher's web sites to certain groups or classes of on-line users beyond the techniques already described without demographic or user information from the content publisher.

Currently a need exists for advertisers to correlate information about advertising campaign success with specific demographic information, such as location, sex, age, income level, etc. A need exists for a system or method to utilize an advertiser's data on registered users to enable an advertiser to target certain groups of users. For example, currently there is no known method for an advertiser to determine what advertisements work best on a certain age group using only the information provided by an advertising server. If a method or system for establishing the success of an advertisement to a certain group or class existed, advertisers could refine their choice of advertisements further based on advertiser needs. For example, a dating service may identify a need to enroll more non-smokers with annual incomes between $50,000 and $80,000. Advertisers could use the information collected about their current users and the advertisements and placements that resulted in their enrollment to refine and target their advertising campaign.

A need exists for a system or method to automatically associate information about an advertisement shown to the on-line user with the user's later submission of information to an advertiser's web site. A need exists to correlate marketing and advertising data collected by advertising servers with data in other databases containing more exhaustive information about on-line users. A method of correlating as such data would be invaluable in maximizing the efficiency of advertising campaigns.

The present invention addresses these needs.

### SUMMARY OF THE INVENTION

The present invention provides for a method of communicating information when a user clicks on an on-line advertisement. The disclosed method provides a technique for communicating identifiers for the particular advertisement that was shown and the placement of the advertisement on a web page to the advertiser. The method discloses steps for an advertiser to associate an advertisement identifier, a placement identifier, data collected automatically upon the user visiting the advertiser's web site, and the data submitted by the user to the advertiser's web site.

### BRIEF DESCRIPTION OF THE DRAWINGS

The novel features believed characteristic of the invention are set forth in the appended claims. The invention, the preferred mode of use, further objectives and advantages thereof, will best be understood by reference to the detailed descriptions of the invention of an illustrative embodiment when read in conjunction with the accompanying drawings, wherein:

FIG. 1 shows a pictorial representation of a simple, yet common advertising system used on the Internet and the relationship between the parties.

FIG. 2A shows the information used by an online user when accessing the advertiser's website.

FIG. 2B shows a pictorial representation of the query string portion of the URL.

FIG. 2C shows an example URL used when accessing an Internet site.

FIG. 3 shows the flow of information when a user visits an advertiser's web site.

### DETAILED DESCRIPTION OF THE INVENTION

The invention will now be explained with reference to the figures.

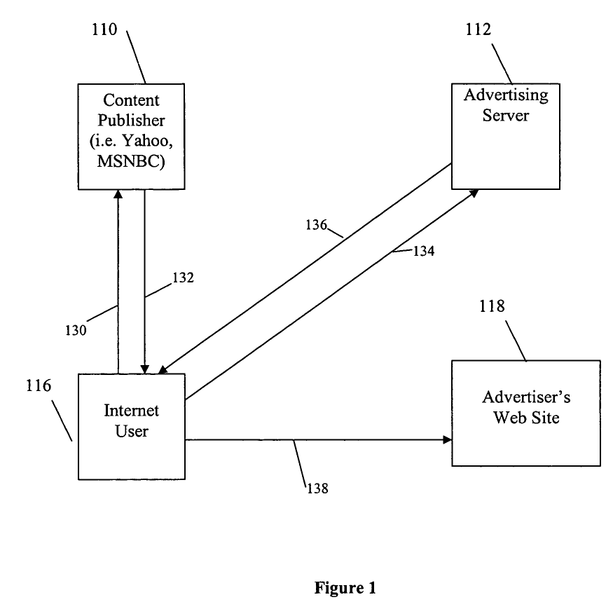

The basic structure of a common on-line advertising system is shown in FIG. 1. The system comprises at least one content publisher web site 110, at least one advertising server 112, and at least one advertiser's target web site 114. A content publisher can be any entity that has an agreement to permit third party advertisers to display advertising as a part of the content publisher's on-line content. The advertisements may appear in forms such as banner ads, text ads, pop-up ads, pop-under ads, or any other advertising technology.

The process of serving an advertisement begins when user browsing an on-line network sends a request 130 to the content publisher's web server for a web page. The content publisher responds by transmitting data 132 to the user's computer. The user's browser receives the data, parses the data, and displays the result. If an advertisement is to be shown as a part of the content, the data received by the user will contain at least one instruction for the user's browser to retrieve an advertisement from an advertising server. The user's browser automatically transmits a request 134 to the advertising server 112 for an advertisement. First, the advertising server transmits 136 a data packet checking the user's computer for any cookie previously installed by the particular advertising server. If a cookie does not exist, the advertising server attempts to install a cookie on the user's machine. The cookie allows an advertising server to track the number of times a particular advertisement has been shown to a specific user and the advertisements the user has clicked on in the past. After checking for a cookie, the advertising server transmits 136 data containing an advertisement and a URL. In the preferred embodiment, the URL points the user to the advertising server. If the user clicks on the advertisement, the advertising server records the click, as well as the placement of the advertisement, including the specific web page and possibly the position of the advertisement on the web page. The web page may be found using the referrer URL. The position of the advertisement on the web page may require some sort of communication from the content publisher, or the dimensions of the advertisement may implicitly indicate the placement of the advertisement on the content publisher's web page. The advertising server transmits 136 an instruction to the user's browser to contact the advertiser's web site 138 using a URL containing a query string. The query string contains identifying information about the advertisement shown.

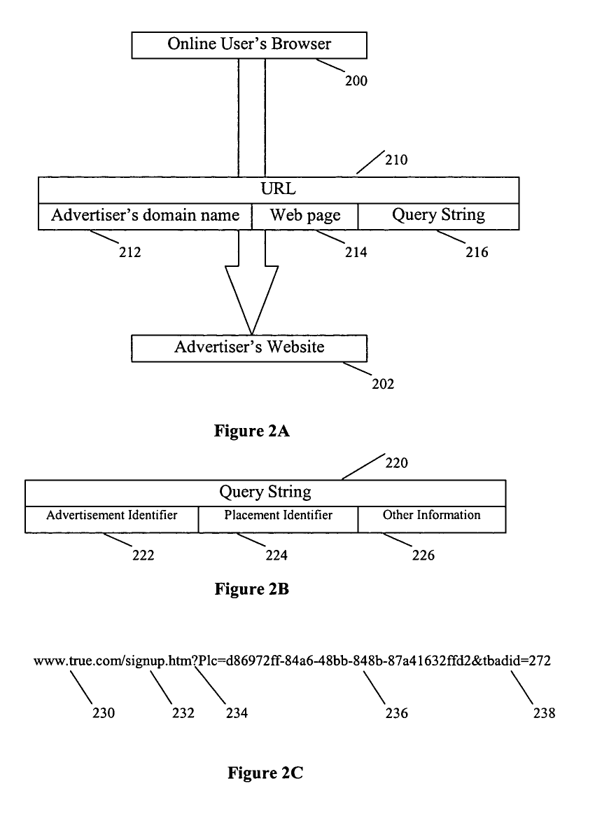

The initial contact by the user's browser and the advertiser's website is shown in FIG. 2A. The user's browser 200 contacts the advertiser's website 202 using the URL 210 provided by the advertising server. The URL consists of a domain name 212, which points to the advertiser's web site, i.e. www.true.com, the specific web page 214 which may include directory path information as well as the specific filename of the web page to be visited, and a query string 216 following the specific web page which contains any number of parameter name-value pairs. The advertiser's website 202 parses the URL 210. It responds by sending the corresponding web page 214 and parses the query string 216 to determine each parameter name-value pair.

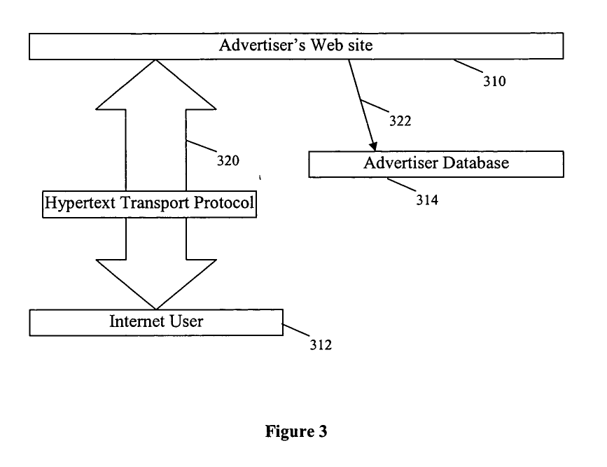

FIG. 3 shows the relationship between the on-line user 310, the advertiser's web site 312, and the advertiser's database 314. The first thing an advertiser's website will generally do is attempt to install a cookie on the user's computer. If the user permits such cookies to be installed, the advertiser is able to track the user as the user visits any page of the advertiser's web site. The advertiser is also able to identify if the user returns to the web site at a later date and time. Alternatives to cookie technology exist such as passing session identifiers to subsequent pages through the URL query string.

The advertiser can record 322 information about the user into the advertiser's database 314. This database may contain information obtained passively about the user such as the web pages visited by a user, the time and date of the visits, and the user's browser and IP address. Ideally, the database will also contain information provided actively 320 by the user to the advertiser's web site 310. In an example, a dating service may collect user information such as name, age, gender, location, education, annual income, and smoking preference during a user registration process. This profile information, containing both the actively and passively collected information, is extremely valuable to a company who may be interested in targeting their advertisements to certain groups of users who have responded positively to specific placements of an advertisement.

### Communicating Advertisement and Placement Identifiers

Several techniques are disclosed for communicating the information about the advertisement that caused the user to visit the advertiser's web site.

The preferred embodiment of a user being forwarded to the advertiser's web site is shown in FIG. 2A. The URL 210 is comprised of a web domain 212, a web page 214, and a query string 216. The query string will usually contain both placement identifier and an advertisement identifier as shown in FIG. 2B. These identifiers may also be incorporated into a single identifier rather than two separate identifiers. A specific content structure of the identifiers is not required as long as the advertiser can understand and interpret the meaning of the identifiers. Generally, the advertising server will use their own unique identifiers and inform the advertiser of the meaning of the identifiers at an earlier time.

The query string is shown in more detail in FIG. 2B. The query string 220 may contain a number of parameter names and corresponding values. The query string generally contains two pieces of relevant advertisement data, the advertisement identifier 222 and the placement identifier 224. The other information 226 may be used by the advertiser's web site for any other purpose. An example of a URL is shown in FIG. 2C. The domain name 230 is www.true.com. The web page file name 232 with directory is /signup.htm. The ‘?’ (Question mark) 234 is a standard separator between the filename and the query string. The placement identifier 236 consists of the parameter name—Plc—and a parameter value—86972ff-84a6-48bb-848b-87a41632ffd2. The advertising identifier 238 consists of the parameter name—tbadid—and a parameter value-272. The advertiser and advertising server may use whatever system to determine the parameter names and values. Generally, the advertising server may define the meaning of the identifiers and the corresponding name, but the advertiser may assign the values and require the advertising server to pass certain values. In former scenario, the advertising server must communicate the meaning of each value to the advertiser prior to analysis of the profile information.

There are a number of alternative methods that can be used to communicate the identifiers to the advertiser. The following two techniques may used in addition to the embodiment described previously. In the first alternative, the advertising server may record the advertisement identifier and placement identifier in a database and pass a record number to the advertiser's web site through the forwarding URL's query string. The advertiser later cross-references the advertiser's database with the advertising server's database using the record number to determine the advertisement and placement information. In another embodiment, the advertising server can record the information about the advertisement, placement, the user's IP address, and the date and time. If the advertising server did not pass any information on to the advertiser's web site, the advertiser will still be able to make extremely accurate conclusions when cross referencing the date, time, and IP address of a user visiting the web site with the date, time, and IP address of records stored in the advertising server's databases.

Regardless of the method used to communicate the advertisement identifier and placement identifier, the advertiser can use that information and categorize users using criteria such as age, gender, location, education, income level, or any other data field of the profile information. This categorized data will help identify the advertisements and corresponding placements that were most successful for a certain identified group. The advertiser may use this information to increase the frequency of certain advertisements shown on certain content publisher's web sites in certain positions on the web site. For instance, a dating service may be interested in acquiring additional females with incomes between $50,000 and $100,000. The profile information collected by the advertiser may show that females in that income group respond best to a certain advertisement on a specific financial web site. The advertiser can then shift resources toward those advertisements that best help them achieve their goal.

Those of ordinary skill in the art will recognize that slight modifications may be made to the steps and processes described above to achieve the same result without departing from the spirit and scope of the invention as described by the claims below.

We claim:

1. A method for associating a user's profile with associated on-line advertisement data comprising the steps:
storing an on-line advertisement and relevant advertisement data;
accessing a content publisher's website by the user wherein the content publisher's web site shows the advertisement;
visiting an advertiser's website upon clicking on the advertisement by the user;
communicating the associated advertisement data to the advertiser within a URL used to direct the user to the advertiser's website;
collecting profile information from the user;
associating the relevant advertising data with the profile information.

2. A method as in claim 1 wherein relevant advertising data comprises an advertisement identifier.

3. The method of claim 2 wherein relevant advertising data further comprises a placement identifier.

4. The method of claim 1 further comprising the step of analyzing the associated data.

5. The method of claim 4 further comprising the step of adjusting an advertising campaign upon analysis of associated relevant advertising data with the profile information.

6. A method for associating a user's profile with associated on-line advertisement data comprising the steps:
storing an on-line advertisement and relevant advertisement data;
accessing a content publisher's website by the user wherein the content publisher's web site shows the advertisement;
visiting an advertiser's website upon clicking on the advertisement by the user;
communicating the relevant advertisement data to the advertiser;
collecting profile information from the user;
associating the relevant advertising data with the profile information.

7. A method as in claim 6 wherein relevant advertising data comprises an advertisement identifier.

8. The method of claim 7 wherein relevant advertising data further comprises a placement identifier.

9. The method of claim 6 further comprising the step of analyzing the associated data.

10. The method of claim 9 further comprising the step of adjusting an advertising campaign upon analysis of associated relevant advertising data with the profile information.
